(19) United States
(12) Patent Application Publication
(10) Pub. No.: US 2026/0045720 A1
(43) Pub. Date: Feb. 12, 2026

(54) PLUG PRONG WITH A SECTION TO BE ENVELOPED BY AN INSULATING LAYER

(71) Applicant: TUN-LI SU, KAOHSIUNG CITY (TW)

(72) Inventor: TUN-LI SU, KAOHSIUNG CITY (TW)

(21) Appl. No.: 18/796,771

(22) Filed: Aug. 7, 2024

(51) Int. Cl. H01R 13/04; H01R 13/405

(52) U.S. Cl. CPC H01R 13/04; H01R 13/405

(57) ABSTRACT

A plug prong comprises, in sequence, a contact section configured to be inserted into a socket, a to-be-enveloped section configured to be enveloped by an insulating layer, a to-be-clamped section configured to be clamped by an inner frame, and a riveting section configured for wire connection via riveting. The to-be-clamped section includes a through-hole. A portion of an inner periphery of the through-hole extends into an area of the to-be-enveloped section. Thus, after injection molding to form a plug product, the through-hole will extend from an inner side to an outer side of an engagement face of the plug product. Therefore, the plastic material can flow smoothly along the inner periphery of the through-hole to provide complete enveloping and then formation of the insulating layer without the risk of lack of material.

### BACKGROUND OF THE INVENTION

The present invention relates to an electrical appliance connector and, more particularly, to a plug prong for an electrical appliance.

In the manufacture of plug prongs in the industry, an insulating layer is provided to avoid electric shock by touching exposed sections of prongs between the plug and a socket (the exposed sections may be formed due to incomplete insertion of the prongs or the prongs inserted into the socket wear and become loose).

As shown in FIG. 12, a plug prong 4 generally includes, in sequence, a contact section 41 configured to be inserted into a socket, a to-be-enveloped section 42 configured to be enveloped by an insulating layer, a to-be-clamped section 43 configured to be clamped by an inner frame, and a riveting section 44 configured for wire connection via riveting. The plug prong 4 shown in FIG. 12 has not been completely processed. The sections are determined by subsequent processing.

In the industry of manufacturing plugs, the prongs are placed into a mold for a first injection molding to form an inner frame with prongs. During the first injection molding, a plastic material envelops the to-be-enveloped section to form an insulating layer. Next, the inner frame with prongs are placed into another mold to proceed with second injection molding to form a whole plug.

When using an injection molding machine to proceed with the first injection molding in a mold to form an inner frame with prongs, in a case that the injecting pressure of the injection molding machine is too large, a flaw of so-called “excessive material” (an excessive amount of plastic material is injected and, thus, overflows out of the predetermined range for the inner frame) often occurs. Thus, the excessively formed portion must be manually scraped off, which is laborsome and uneconomic. On the other hand, when the injecting pressure of the injection molding machine is insufficient, a flaw of so-called “lack of material” (the amount of injected plastic material is insufficient to support the inner frame and, thus, forms a defective product). This flaw resulting from lack of material is difficult to remedy and, thus, often fails to meet the safety regulations.

Thus, a need exists for a novel plug prong that mitigates and/or obviates the above drawbacks.

### BRIEF SUMMARY OF THE INVENTION

In view of the above drawbacks in the prior art, an objective of the present invention is to provide a plug prong comprising, in sequence, a contact section configured to be inserted into a socket, a to-be-enveloped section configured to be enveloped by an insulating layer, a to-be-clamped section configured to be clamped by an inner frame, and a riveting section configured for wire connection via riveting. The to-be-clamped section includes a through-hole, and a portion of an inner periphery of the through-hole extends into an area of the to-be-enveloped section. Namely, the through-hole extends in both the to-be-clamped section and the to-be-enveloped section.

The through-hole permits catching of the insulating layer. Furthermore, when proceeding with the first injection molding for the insulating layer and the inner frame, the plastic material for forming the inner frame may also flow along the inner periphery of the through-hole which extends in both the to-be-clamped section and the to-be-enveloped section, such that the through-hole will extend from an inner side to an outer side of the outermost side of the inner frame and will also extend from an inner side to the outer side of an engagement face of a plug product after the injection molding for forming the plug product. Specifically, the plastic material firstly fulfills the need of formation of the inner frame and then flows to the inner periphery of the through-hole to form the insulating layer. Therefore, the plastic material can flow smoothly along the inner periphery of the through-hole to provide complete enveloping and then formation of the insulating layer without the risk of lack of material. Since the plastic material flows smoothly, the flaw in the appearance of the product and failure to meet the safety regulation resulting from lack of material can be avoided when forming the plug product.

The through-hole may be circular, elliptic, square, or rectangular in cross section.

The present invention will become clearer in light of the following detailed description of illustrative embodiments of this invention described in connection with the drawings.

### DESCRIPTION OF THE DRAWINGS

FIG. 1 is a diagrammatic elevational view of a plug prong of an embodiment according to the present invention.

FIG. 2 is a diagrammatic elevational view of a plug prong of another embodiment according to the present invention.

FIG. 3 a diagrammatic elevational view of a plug prong of a further embodiment according to the present invention.

FIG. 4 a diagrammatic elevational view of a plug prong of still another embodiment according to the present invention.

FIG. 5 is a diagrammatic perspective view illustrating coupling of plug prongs according to the present invention and an inner frame.

FIG. 6 is a diagrammatic perspective view illustrating coupling of plug prongs according to the present invention and an inner frame of another type.

FIG. 7 is a diagrammatic perspective view illustrating coupling of plug prongs according to the present invention and an inner frame.

FIG. 8 is a diagrammatic cross sectional view illustrating the plug prong of an embodiment according to the present invention.

FIG. 9 is a diagrammatic cross sectional view illustrating the plug prong of another embodiment according to the present invention.

FIG. 10 is a diagrammatic perspective view of a plug prong of an embodiment according to the present invention.

FIG. 11 is a diagrammatic perspective view of a plug prong of another embodiment according to the present invention.

FIG. 12 is a diagrammatic perspective view of a conventional plug prong.

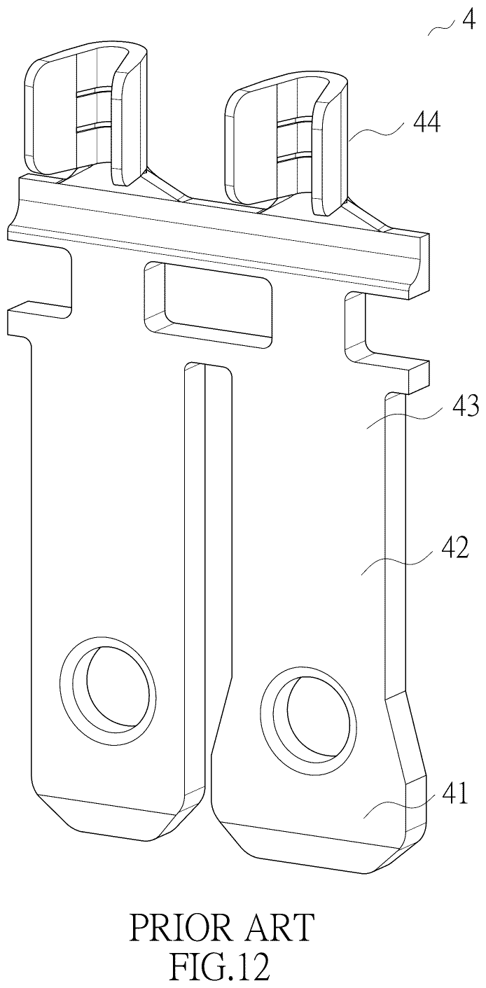

### DETAILED DESCRIPTION OF THE INVENTION

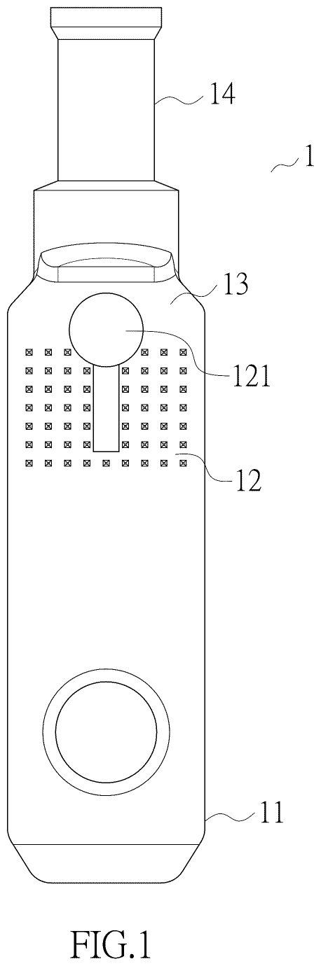

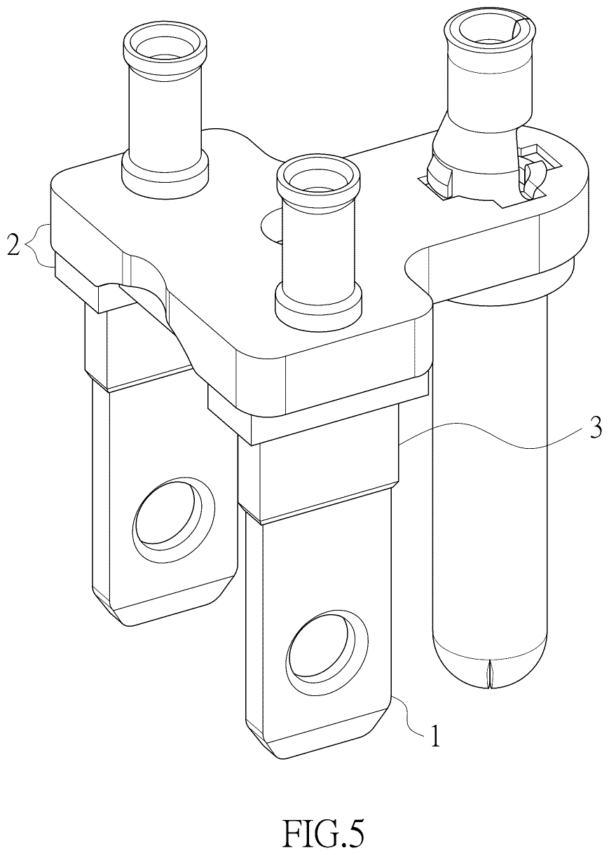

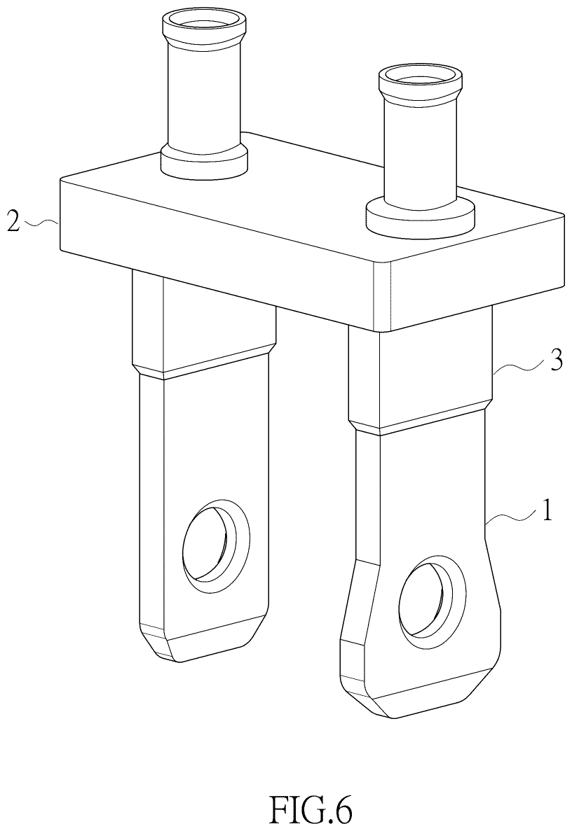

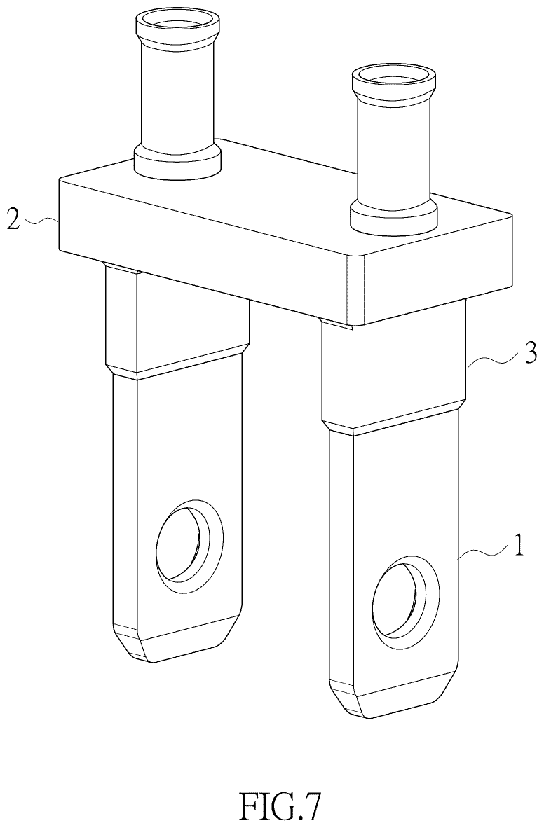

With reference to FIG. 1, a plug prong 1 according to the present invention comprises, in sequence, a contact section 11 configured to be inserted into a socket, a to-be-enveloped section 12 configured to be enveloped by an insulating layer 3 (see FIGS. 5-7), a to-be-clamped section 13 configured to be clamped by an inner frame 2 (see FIGS. 5-7), and a riveting section 14 configured for wire connection via riveting. The present invention is featured by that the to-be-clamped section 13 includes a through-hole 121. A portion of an inner periphery of the through-hole 121 extends into an area of the to-be-enveloped section 12. Namely, the through-hole 121 extends in both the to-be-clamped section 13 and the to-be-enveloped section 12.

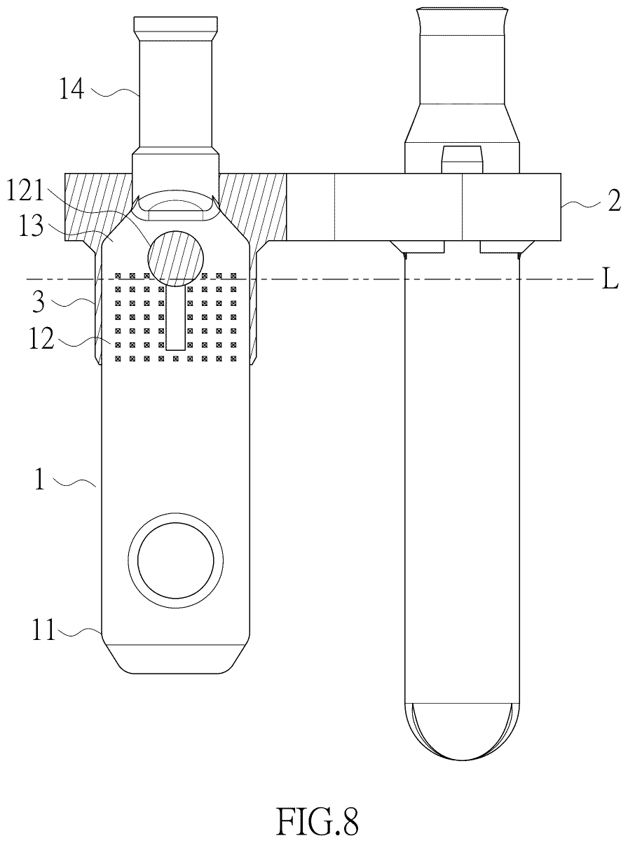

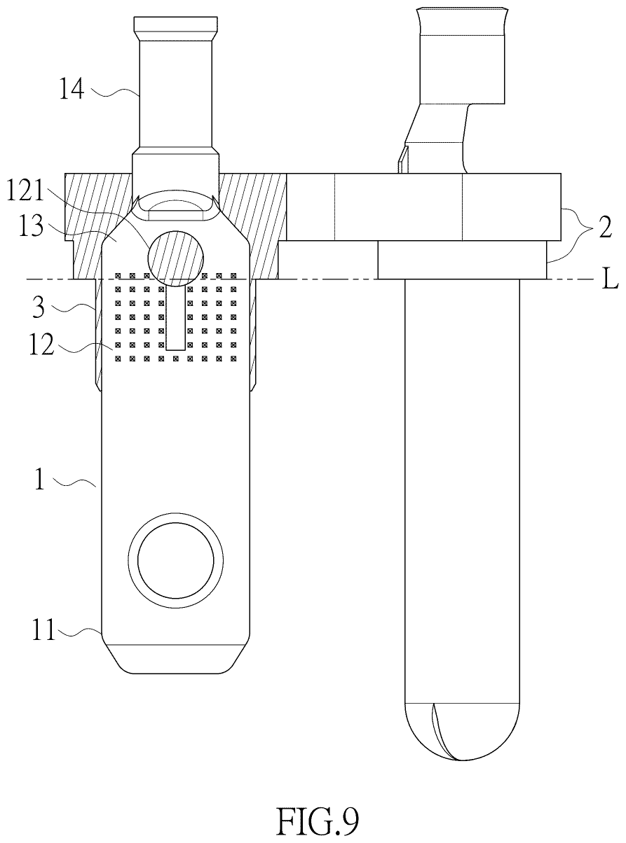

With reference to FIGS. 8 and 9, the through-hole 121 extends in both the to-be-clamped section 13 and the to-be-enveloped section 12. Thus, the through-hole 121 will extend from an inner side to an outer side of the outermost side of the inner frame 2 and will also extend from an inner side to the outer side of an engagement face L of a plug product after the injection molding for forming the plug product.

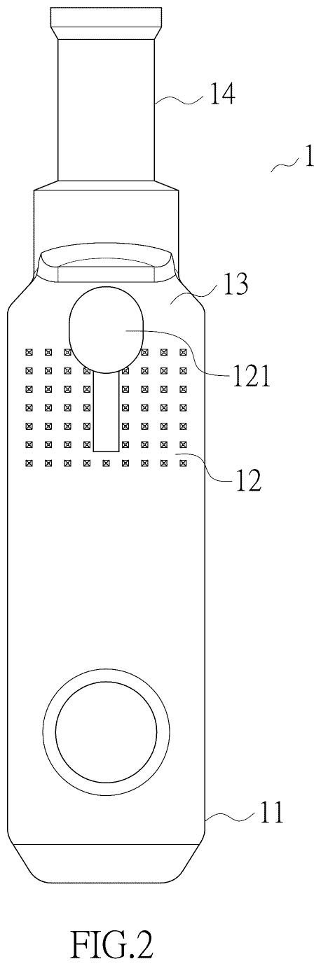

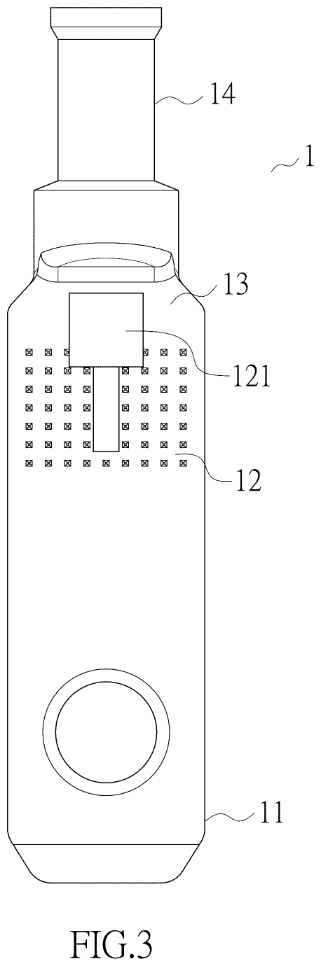

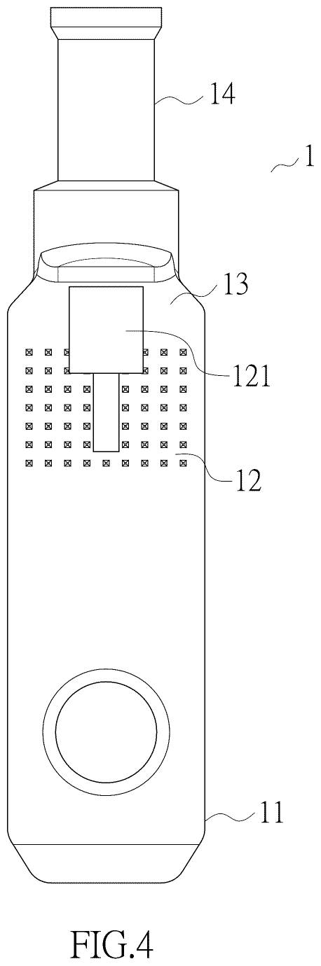

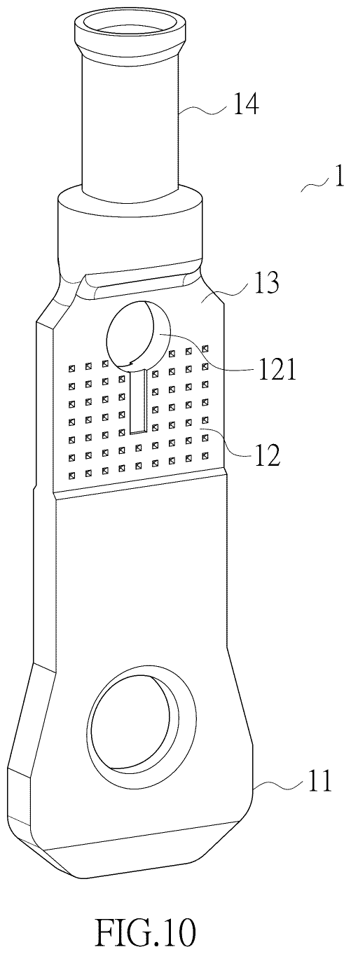

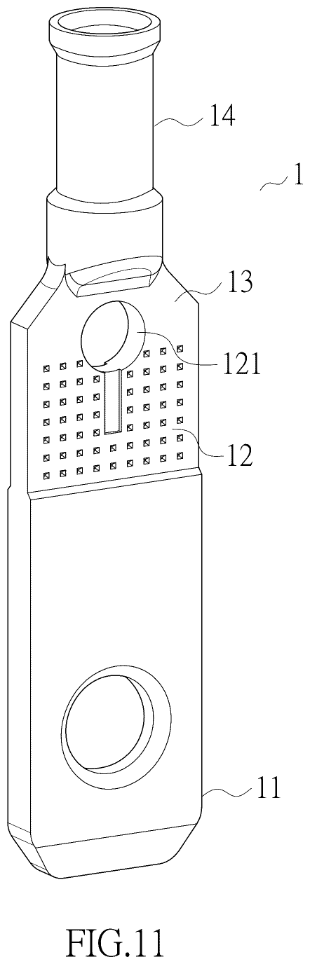

The through-hole 121 may be circular (see FIGS. 1, 10, and 11), elliptic (see FIG. 2), square (see FIG. 3), or rectangular (see FIG. 4) in cross section or may have other shapes in response to the shape of the prongs or the procedures thereof. Furthermore, the length of the through-hole 121 in the to-be-enveloped section 12 may be longer or shorter without restriction.

The through-hole 121 permits catching of the insulating layer 3. Furthermore, when proceeding with the first injection molding for the insulating layer 3 and the inner frame 2, the plastic material for forming the inner frame 2 may also flow along the inner periphery of the through-hole 121 which extends in both the to-be-clamped section 13 and the to-be-enveloped section 12. The plastic material firstly fulfills the need of formation of the inner frame 2 and then flows to the inner periphery of the through-hole 121 to form the insulating layer 3. Therefore, the plastic material can flow smoothly along the inner periphery of the through-hole 121 to provide complete enveloping and then formation of the insulating layer 3 without the risk of lack of material. Since the plastic material flows smoothly, the flaw in the appearance of the product and failure to meet the safety regulation resulting from lack of material can be avoided when forming the plug product.

Although specific embodiments have been illustrated and described, numerous modifications and variations are still possible without departing from the scope of the invention. The scope of the invention is limited by the accompanying claims.

What is claimed is:

1. A plug prong comprising, in sequence, a contact section configured to be inserted into a socket, a to-be-enveloped section configured to be enveloped by an insulating layer, a to-be-clamped section configured to be clamped by an inner frame, and a riveting section configured for wire connection via riveting, characterized in that: the to-be-clamped section includes a through-hole, and a portion of an inner periphery of the through-hole extends into an area of the to-be-enveloped section.

2. The plug prong as claimed in claim 1, wherein the through-hole is circular in cross section.

3. The plug prong as claimed in claim 1, wherein the through-hole is elliptic in cross section.

4. The plug prong as claimed in claim 1, wherein the through-hole is square in cross section.

5. The plug prong as claimed in claim 1, wherein the through-hole is rectangular in cross section.
